(19) United States
(12) Patent Application Publication
(10) Pub. No.: US 2007/0245171 A1
(43) Pub. Date: Oct. 18, 2007

(54) Methods and apparatus to perform distributed memory checking

(76) Inventors: Patrick Ohly, Bonn (DE); Ramesh Peri, Austin, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/390,013

(22) Filed: Mar. 27, 2006

(51) Int. Cl. G06F 9/46; G06F 11/00

(52) U.S. Cl. 714/42

(57) ABSTRACT

Methods and apparatus to perform distributed memory checking for distributed applications are disclosed. An example method comprises sending data from a first process to a second process, and sending distributed memory check data to the second process, wherein the distributed memory check data represents an initialization state of the data at the first process.

### FIELD OF THE DISCLOSURE

This disclosure relates generally to distributed applications and, more particularly, to methods and apparatus to perform distributed memory checking for distributed applications.

### BACKGROUND

Memory checking during development of a software application allows a programmer to be aware of, locate and/or resolve accesses to ill-defined and/or un-defined data and/or data structures. Memory checking may be performed by a memory checker that tracks and/or records when memory locations are written (i.e., initialized and/or defined) thereby creating “definedness” information and/or data. In particular, a definedness bit can be associated with each piece of data (e.g., a memory location, a bit, a byte, a word, a variable, a data structure, etc.). If the definedness bit is TRUE, then the piece of data has been initialized and/or otherwise defined. When a piece of data is read and/or used, the memory checker may then use the associated definedness bit to determine if the piece of data is initialized and/or otherwise defined. If the piece of data is not initialized and/or otherwise defined, the memory checker can log the memory read and/or usage as a potentially invalid memory access. The log of potentially invalid memory accesses may then be reviewed and/or otherwise analyzed by the programmer to facilitate correctness and/or improvements to the software.

Today, memory checking techniques and/or methods such as those described above rely on the co-location of processes that write, use and/or read shared data (e.g., processes executing in a common address space of a processor). However, in distributed applications where processes are executing on physically separate processors having physically separate memory spaces, a memory checker associated with a first process executing on a first processor is not aware of memory write operations associated with a second process executing on a second processor and, thus, the memory checker cannot correctly determine the validity of data read and/or used by the first process.

### BRIEF DESCRIPTION OF THE DRAWINGS

FIG. 1 is a schematic illustration of an example system to perform distributed memory checking.

FIG. 2 illustrates an example data structure for sending distributed memory check data.

FIGS. 3A and 3B, 4 and 5 are flowcharts representative of example machine accessible instructions which may be executed to implement distributing memory checking in the example system of FIG. 1.

FIG. 6 is a schematic illustration of an example processor platform that may be used and/or programmed to execute the example machine accessible instructions illustrated in FIGS. 3A, 3B, 4 and/or 5 to implement the example distributed memory checking system of FIG. 1.

### DETAILED DESCRIPTION

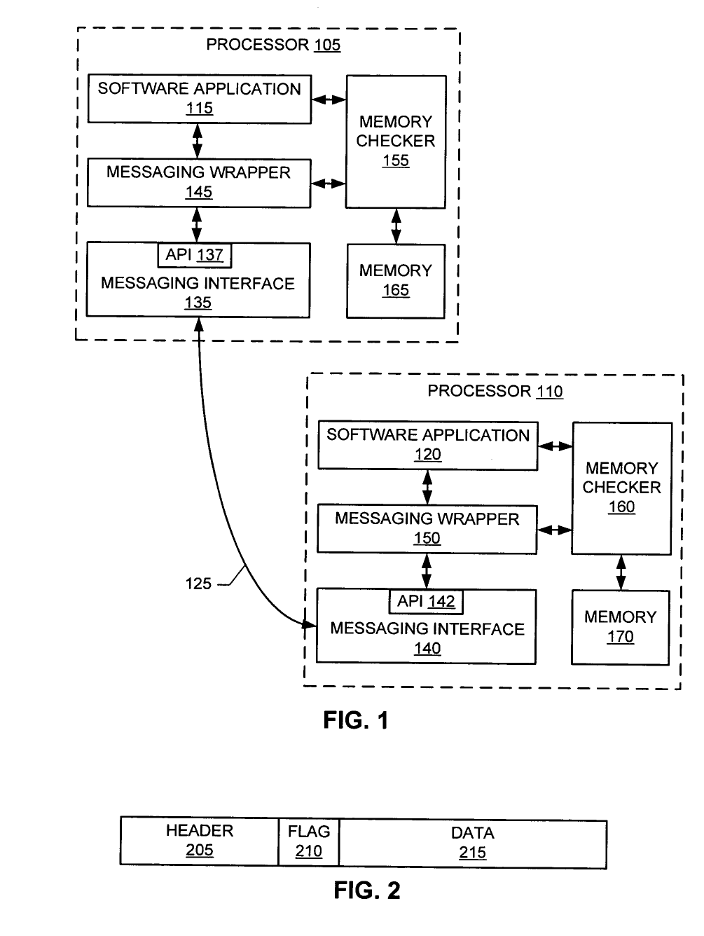

FIG. 1 is a schematic illustration of an example system to perform distributed memory checking. In the example system of FIG. 1, an example distributed application is cooperatively implemented via generally contemporaneous execution of machine accessible instructions by two processors 105 and 110. In particular, a first process (i.e., software application) 115 executed by the example processor 105 and a second software application 120 executed by the example processor 110 cooperatively realize the example distributed application using any variety of distributed computing algorithms, techniques and/or methods. In the example system of FIG. 1, the example software applications 115 and 120 implement different machine accessible instructions. Alternatively, the example software applications 115 and 120 may implement similar and/or identical machine accessible instructions.

For simplicity and ease of understanding, the following disclosure references the example two processor system of FIG. 1. However, distributed applications and/or the methods and apparatus disclosed herein to perform distributed memory checking may be implemented by systems incorporating any number and/or variety of processors. For example, one or more processes of a distributed application may be implemented by a single processor, a single process may be implemented by each processor, etc.

The example software applications 115 and 120 may be developed using any variety of programming tools and/or languages and may be used to implement any variety of distributed applications. In the example system of FIG. 1, the processors 105 and 110 may be implemented within a single computing device, system and/or platform or may be implemented by separate devices, systems and/or platforms. Further, the example processors 105 and 110 may execute any variety of operating system(s).

To create a communication path and/or link over which the example software applications 115 and 120 may communicate and/or exchange application data, the example processors 105 and 110 of FIG. 1 are communicatively coupled via any variety of communication devices, cables, buses, protocols, systems and/or networks 125. For example, the example processors 105 and 110 may be coupled via Ethernet-based network interfaces and a local area network (LAN) network and/or via the Internet.

To provide a distributed application messaging mechanism between the example software applications 115 and 120, the example system of FIG. 1 includes any variety of messaging interfaces 135 and 140. The example messaging interfaces 135 and 140 of FIG. 1 facilitate the exchange of, for example, distributed application messages, between the example software application 115 and 120. In the example of FIG. 1, the example messaging interfaces 135 and 140 implement a library and/or a run-time system implementing messaging functions in accordance with a messaging passing interface (MPI) standard for distributed applications. However, the messaging interfaces 135 and 140 may implement any variety of additional and/or alternative messaging interface(s) for distributed computing processes.

In the example system of FIG. 1, the example messaging interfaces 135 and 140 provide application programming interfaces (API) 137 and 142 to allow the example software applications 115 and 120 to interact with the messaging interfaces 135 and 140, respectively. Additionally or alternatively, any variety of communication schemes may be implemented between the example software applications 115 and 120 and the example messaging interfaces 135 and 140. In an example application data exchange, the example software application 115 of FIG. 1 uses an API call (e.g., MPI_SEND) provided by the example messaging interface 135 of FIG. 1 to send an MPI message conveying application data from the software application 115 to the software application 120. In response to the API call, the example messaging interface 135 of FIG. 1 sends the MPI message to the messaging interface 140 of the message receiving processor 110 via the communication path 125. The example messaging interface 140 of FIG. 1 subsequently notifies the example software application 120 via another API function that an MPI message conveying application data was received by the messaging interface 140. The example software application 120 of FIG. 1 can then use yet another API call (e.g., MPI_RECV) to obtain the MPI message and the conveyed application data from the example messaging interface 140. Additionally or alternatively, and via potentially different API calls (e.g., MPI_WAIT, MPI_TEST), the example software application 140 of FIG. 1 may periodically or aperiodically poll the example messaging interface 140 to determine if MPI messages and/or application data has arrived. Persons of ordinary skill in the art will readily appreciate that the example software applications 115 and 120 and the example messaging interfaces 135 and 140 can use the API and/or any variety of interface(s) to exchange application data and/or MPI messages in any variety of ways between the software applications 115 and 120.

Any number of communication contexts may be used to facilitate communications between the processes implementing a distributed application. In the example of FIG. 1, MPI communicators are used to define one or more communication contexts. MPI communicators specify a group of processes inside and/or between which communications may occur, such as, for example to logically group the processes 115 and 120 to form the example distributed application of FIG. 1 (i.e., application MPI communicators). Persons of ordinary skill in the art will readily appreciate that an MPI communicator is not a physical entity but rather a logical reference to a set of processes. A distributed application may include more than one MPI communicator such as, for example, an MPI communicator by which all of the processes of the distributed application may communicate (i.e., a global MPI communicator), an MPI communicator between two specific processes of the distributed application (i.e., a point-to-point MPI communicator), etc.

To specify the source and/or destination for each API call, in the example system of FIG. 1, each software application (i.e., process) is assigned a rank, or node number, to identify itself uniquely inside each communicator. Further, each sending point-to-point MPI API call implicitly uses the rank of the sending process (e.g., software application 115) and contains the rank of a destination process (e.g., software application 120); vice-versa for receiving point-to-point MPI API calls. The actual internal MPI message which is sent over 125 to implement an API call may or may not include the sending rank and/or the destination rank depending upon the type of the resultant MPI message and/or depending upon implementation details of the messaging interfaces 135 and/or 140. For example, the messaging interfaces 135 and 140 could rely on a point-to-point connection to exchange application data. Since the point-to-point connection inherently represents the sending and receiving processes, the MPI messages sent via the MPI communicator do not need to include the sending and destination ranks.

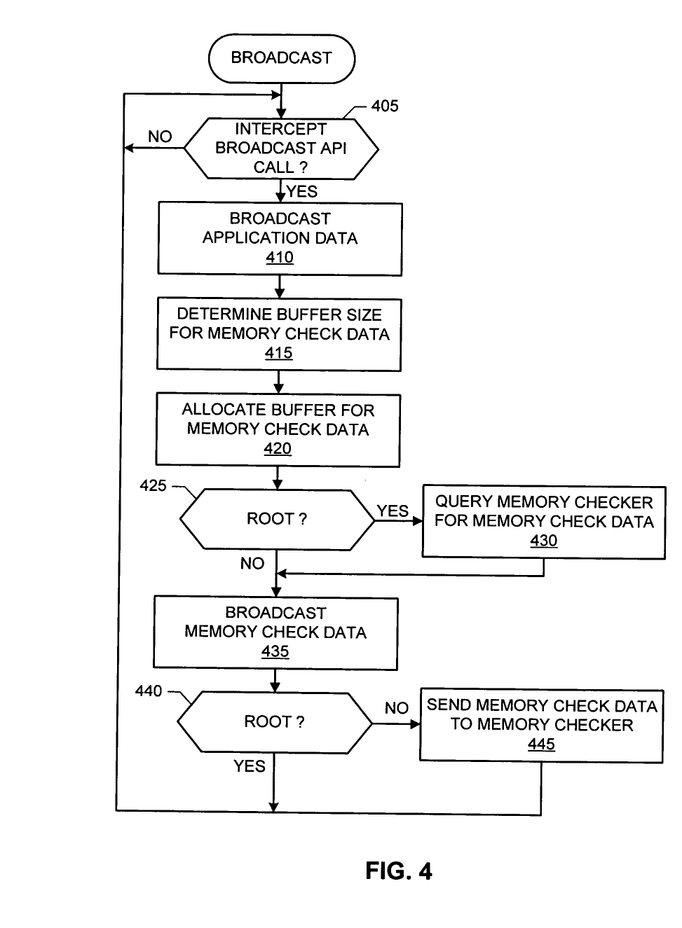

To intercept all API calls made by a software application to a messaging interface, the example system of FIG. 1 includes messaging wrappers 145 and 150. Each of the example messaging wrappers 145 and 150 of FIG. 1 intercepts each API call made by an associated software application, potentially modifies the intercepted calls, and then, among other things, calls the API function specified by the intercepted API call. In the illustrated example, there is one messaging wrapper for each software application and messaging interface pair. Further, the example messaging wrappers 145 and 150 of FIG. 1 implement a wrapper function for each API call utilized by the software applications 115 and/or 120 and/or provided by the messaging interfaces 135 and/or 140. Example machine accessible instructions that may be carried out to implement the example messaging wrappers 145 and/or 150 are discussed below in connection with FIGS. 3A, 3B, 4 and 5. Other example wrapper functions may be readily constructed by persons of ordinary skill in the art based upon the examples of FIGS. 3A-5.

To track memory accesses (e.g., reads and/or writes) made by a process and to detect reads from un-initialized memory, the example system of FIG. 1 includes memory checkers 155 and 160. In the illustrated example of FIG. 1, there is one memory checker for each software application, messaging interface and messaging wrapper combination. The example memory checkers 155 and 160 of FIG. 1 monitor reads and/or writes made by their associated software application using any variety of techniques and/or methods. In the example of FIG. 1, memory checks performed by a memory checker (e.g., checker 160) are made with respect to the local address space of the associated software application (e.g., process 120). The resultant memory check data (e.g., definedness data, memory access error log, etc.) is stored in any variety of memory 165 and 170 for later recall, reference and/or analysis by, for example, a programmer developing and/or testing a distributed application being implemented by the example system of FIG. 1.

When a software application (e.g., process 115) sends application data to another software application (e.g., process 120) via an MPI message, the messaging wrapper 145 associated with the software application intercepts the API call made by the sending process 115 to the corresponding messaging interface 135. The example messaging wrapper 145 of FIG. 1 then calls the original API function specified by the intercepted API call and provided by the messaging interface 135 to send the application data via a first MPI message to the receiving process 120. The example messaging wrapper 145 also queries the memory checker 155 to obtain definedness data for the application data being sent. The messaging wrapper 145 then sends the definedness data (i.e., distributed memory check data) to the receiving processor 110 in a second MPI message via the messaging interface 135.

The distributed memory check data sent in the second MPI message includes the information to allow the example memory checker of the receiving processor (e.g., the example memory checker 160 of the processor 110 of FIG. 1) to perform memory checking for each memory access performed by the process 120 within the sent application data. In the example system of FIG. 1, the distributed memory check data includes a plurality of bits indicating which pieces of data (e.g., bits, bytes, words, variables, data structures, etc.) in the application data are initialized (i.e., defined) and/or which are not. In the illustrated example, one definedness bit is used for each data bit of the application data.

At the receiving processor (e.g., the example processor 110 in the example of FIG. 1), when the first MPI message containing the application data is intercepted by the example messaging wrapper 150 it is forwarded to the example process 120. Then, when the example messaging wrapper 150 of FIG. 1 intercepts the second MPI message, the example messaging wrapper 150 provides the definedness data (i.e., distributed memory check data) to the example memory checker 160. The example memory checker 160 of FIG. 1, using any variety of techniques and/or methods, utilizes the definedness data to detect, for example, memory reads to un-initialized portions (e.g., binary bits) of the application data received by the example process 120 via the first MPI message.

When the example messaging wrapper 145 of FIG. 1 queries the example memory checker 155 for the definedness data, the example messaging wrapper 145 provides the addresses and/or address range for the corresponding application data. It does not need to provide the application data itself. Thus, the example memory checker 155 of FIG. 1 returns a block of data (e.g., an array) containing the definedness bits to the messaging wrapper 145. When the example messaging wrapper 150 at example processor 110 receives the distributed memory check data in the second MPI message, the example messaging wrapper 150 provides both the addresses and/or the address range and the definedness bits to the example memory checker 160.

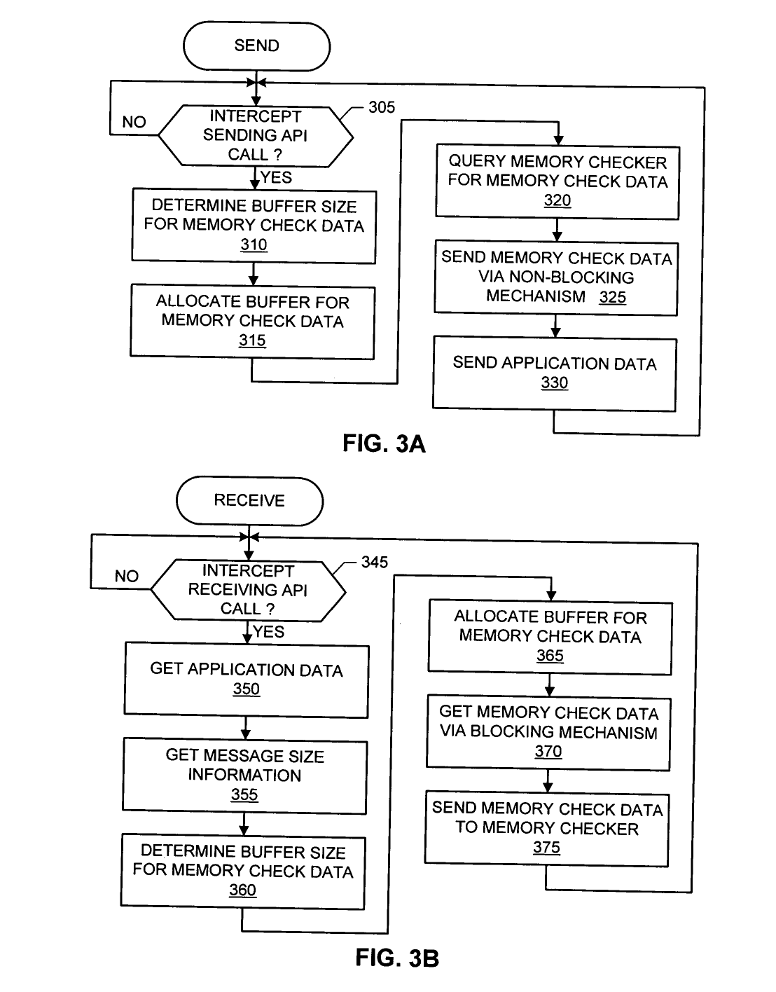

In the illustrated example of FIG. 1, the distributed memory check data may be compressed by, for example, the example messaging wrapper 145, prior to being sent in the second MPI message. FIG. 2 illustrates an example data structure used to send the distributed memory check data in the second MPI message. In the example of FIG. 2, the distributed memory check data structure includes message header 205, a flag 210 which indicates whether the definedness bits are compressed or not, and a varying amount of compressed or uncompressed definedness bits 215. In the example of FIG. 2, the message header 205 has constant size, but may be zero length if not used. If compression of the definedness bits results in a reduction in size of the data, then compressed data is sent. If not, the uncompressed original definedness bits are sent. In both cases, the maximum buffer size for the second MPI message is the size of the message header plus the size of the MPI message carrying the application data.

Returning to FIG. 1, at a receiving messaging wrapper, the receiving messaging wrapper may use, for example, the MPI_PROBE function to determine the size of the second MPI message and, thus, know the buffer size necessary to hold the distributed memory check data (i.e., definedness data) before it is received. Additionally or alternatively, the receiving messaging wrapper may use the size of the already received application data message to determine the maximum size of the distributed memory check data and then use the maximum size to allocate the buffer for the definedness data.

Since MPI standards allow for selectively receiving MPI messages out of order based on certain attributes (e.g., source rank, etc.), in the example system of FIG. 1, each MPI message conveying the distributed memory check (e.g., definedness) data is sent using the same MPI message tag as the MPI message carrying the corresponding application data. Likewise, the same source process rank is used for both messages. Additionally, in the illustrated example of FIG. 1, MPI messages conveying distributed memory check data are sent using a shadow MPI communicator which identifies the same processes in the same order as the application MPI communicator used to send the corresponding MPI messages conveying the application data.

In the example system of FIG. 1, when a messaging wrapper sends an MPI message with the distributed memory check data, the example messaging wrapper uses a non-blocking MPI message sending mechanism (e.g., MPI_ISEND) to ensure that the sending software application can proceed while the MPI message with the distributed memory check data is being sent. Further, since a receiving process may use, for example, a non-blocking mechanism and/or wildcards to receive the next message from any source and/or tag, the corresponding messaging wrapper waits until the MPI message with the application data is received and then uses the source and tag attributes from the MPI message to receive the MPI message carrying the definedness data. Additionally, to ensure correctness of the memory checking, the example messaging wrappers 145 and 150 of FIG. 1 use a blocking MPI receive mechanism to prevent a receiving process from accessing the application data until the distributed memory check (i.e., definedness) data is received and provided to the example memory checker 160. Moreover, the order of sending the MPI message conveying the application data and the MPI message conveying the distributed memory check data may be reversed from that described above.

It will be readily apparent to persons of ordinary skill in the art that the above described methods can be implemented without modifying and/or otherwise changing the example software applications 115 and 120 and/or the example messaging interfaces 135 and 140. Alternatively or additionally, the software applications 115 and/or 120 and/or the messaging interfaces 135 and/or 140 may be modified to implement and/or otherwise incorporate some or all of the example messaging wrappers 145 and/or 150 of FIG. 1.

It will also be readily apparent to persons of ordinary skill in the art that the above described methods can be used to send application data and the corresponding distributed memory check data in any direction between any two or more processes (e.g., processes 115, 120) cooperatively implementing a distributed application. The conveyed definedness data and application data allows the illustrated example system to perform distributed memory checking across multiple processors implementing a distributed application.

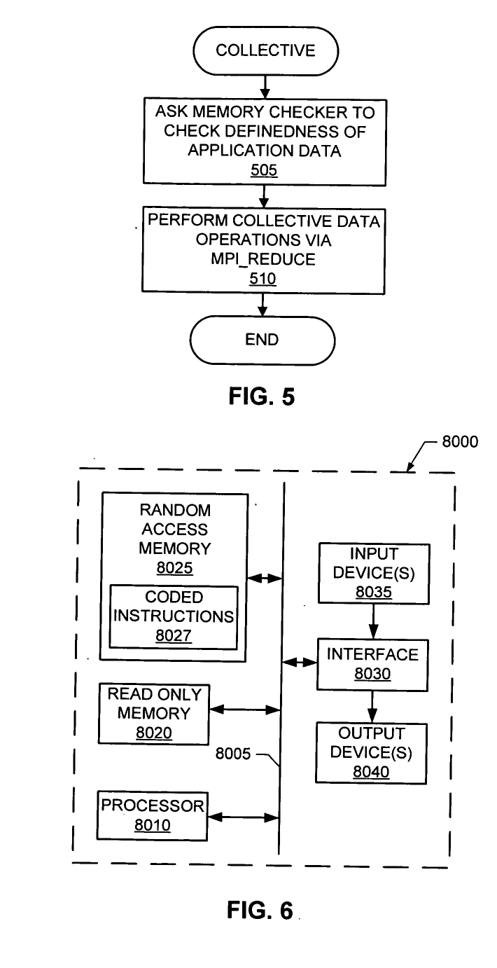

FIGS. 3A, 3B, 4, and 5 are flowcharts representative of example machine accessible instructions that may be executed to implement distributed memory checking in the example system of FIG. 1. The example machine accessible instructions of FIGS. 3A-5 may be executed by a processor, a controller and/or any other suitable processing device. For example, the example machine accessible instructions of FIGS. 3A-5 may be embodied in coded instructions stored on a tangible medium such as a flash memory, or random access memory (RAM) associated with a processor (e.g., the processor 8010 shown in the example processor platform 8000 and discussed below in conjunction with FIG. 6). Alternatively, some or all of the example flowcharts of FIGS. 3A-5 may be implemented using an application specific integrated circuit (ASIC), a programmable logic device (PLD), a field programmable logic device (FPLD), discrete logic, hardware, firmware, etc. Also, some or all of the example flowcharts of FIGS. 3A-5 may be implemented manually or as combinations of any of the foregoing techniques, for example, a combination of firmware, software and/or hardware. Further, although the example machine accessible instructions of FIGS. 3A-5 are described with reference to the flowcharts of FIGS. 3A-5, persons of ordinary skill in the art will readily appreciate that many other methods of implementing distributed memory checking in the example system of FIG. 1 may be employed. For example, the order of execution of the blocks may be changed, and/or some of the blocks described may be changed, eliminated, sub-divided, or combined. Additionally, persons of ordinary skill in the art will appreciate that the example machine accessible instructions of FIGS. 3A-5 may be carried out sequentially and/or carried out in parallel by, for example, separate processing threads, processors, devices, circuits, etc.

The example machine accessible instructions of FIG. 3A begin with a messaging wrapper waiting to intercept an API call to send application data to another process (block 305). When an API call to send application data is intercepted (block 305), the intercepting messaging wrapper determines the size of the buffer required to hold the definedness bits based on the size of the application data being sent (block 310) and allocates the buffer for the definedness bits (block 315). The intercepting messaging wrapper then queries a memory checker for the definedness bits for the application data (block 320) and sends the definedness data in an MPI message via a non-blocking mechanism (e.g., MPI_ISEND) (block 325). The intercepting messaging wrapper then sends the application data in an MPI message using either a non-blocking mechanism (e.g., MPI_ISEND) or a blocking mechanism (e.g., MPI_SEND) depending upon whether the intercepted API call was a non-blocking or blocking API call (block 330). Additionally, the intercepting messaging wrapper may collaborate with the memory checker to suppress invalid reports when sending (partially) undefined data. Control then returns to block 305 to wait to intercept another sending API call.

The example machine accessible instructions of FIG. 3B begin with a messaging wrapper waiting to intercept an API call to receive application data sent by another process (block 345). When an API call to receive application data is intercepted (block 345), the intercepting messaging wrapper receives the application data using either a non-blocking mechanism (e.g., MPI_IRECV) or a blocking mechanism (e.g., MPI_RECV) depending upon whether the intercepted API call was a non-blocking or blocking API call (block 350). The intercepting messaging wrapper determines the size of the received MPI message using, for example, MPI_GET_COUNT (block 355) and uses the message size to determine the size of the buffer for the definedness bits (block 360). Based upon the determined size of the buffer for the definedness bits, the intercepting messaging wrapper allocates a buffer for the definedness bits (block 365) and then receives the MPI message containing the definedness bits via a block mechanism (e.g., MPI_RECV) (block 370). The intercepting messaging wrapper then sends the received definedness bits to its associated memory checker (block 375) and control returns to block 345 to wait to intercept another receiving API call.

The example machine accessible instructions of FIG. 4 begin with a messaging wrapper waiting to intercept a broadcast API call to send application data to a plurality of processes (block 405). When an API call to broadcast application data is intercepted (block 405), the intercepting messaging wrapper broadcasts the application data using, for example, MPI_BCAST (block 410). The intercepting messaging wrapper then determines the size of the buffer required to hold the definedness bits based on the size of the application data being sent (block 415) and allocates the buffer for the definedness bits (block 420). If the process broadcasting the application is the root of the broadcast (block 425), the intercepting messaging wrapper queries its associated memory checker for the definedness bits for the application data (block 430). The intercepting messaging wrapper then broadcasts the definedness bits, using either individual MPI messages or collective API calls (block 435). When using a collective API call, the intercepting messaging wrapper may use the shadow communicator or the application communicator. If the process broadcasting the application is not the root of the broadcast (block 440), the intercepting messaging wrapper sends the received definedness bits to a memory checker (block 445). Control then returns to block 405 to wait to intercept another broadcasting API call. Persons of ordinary skill in the art will readily appreciate that other collective operations that transmit data (e.g., scatter or gather operations) can be handled in a similar way.

FIG. 5 illustrates an example collective wrapper function (e.g., MPI_REDUCE) that modifies application data in addition to transmitting application data. The example machine accessible instructions of FIG. 5 begin when a messaging wrapper intercepts an API call initiating the collective action. The intercepting messaging wrapper determines the definedness bits for the application data by querying the associated memory checker (block 505) and warns about undefined data before performing the collective operation (e.g., MPI_REDUCE) by calling the original function implemented by a messaging interface (block 510). Alternatively, the intercepting messaging wrapper may instruct the memory checker to perform its normal checks. Control then returns from the example machine accessible instructions of FIG. 5.

While the above example methods and apparatus disclosed above send memory check data via a separate API call and/or MPI message via a shadow MPI communicator, persons of ordinary skill in the art will readily appreciate that memory check data could be sent using any variety of additional or alternative methods and/or apparatus. For example, memory check data could be packed and/or combined with the application data and be sent via the same API call and/or the same MPI message as the application data. The memory check data could also be sent via a different API call and/or a different MPI message via an application MPI communicator rather than a shadow MPI communicator.

FIG. 6 is a schematic diagram of an example processor platform 8000 that may be used and/or programmed to implement distributed memory checking in the example system of FIG. 1. For example, the processor platform 8000 can be implemented by one or more general purpose microprocessors, microcontrollers, etc.

The processor platform 8000 of the example of FIG. 6 includes a general purpose programmable processor 8010. The processor 8010 executes coded instructions 8027 present in main memory of the processor 8010 (e.g., within a RAM 8025). The processor 8010 may be any type of processing unit, such as a microprocessor from the Intel® families of microprocessors. The processor 8010 may execute, among other things, the example machine accessible instructions of FIGS. 3A-5 to implement distributed memory checking in the example system of FIG. 1.

The processor 8010 is in communication with the main memory (including a read only memory (ROM) 8020 and the RAM 8025) via a bus 8005. The RAM 8025 may be implemented by dynamic random access memory (DRAM), Synchronous DRAM (SDRAM), and/or any other type of RAM device, and ROM may be implemented by flash memory and/or any other desired type of memory device. Access to the memory 8020 and 8025 is typically controlled by a memory controller (not shown) in a conventional manner.

The processor platform 8000 also includes a conventional interface circuit 8030. The interface circuit 8030 may be implemented by any type of well-known interface standard, such as an external memory interface, serial port, general purpose input/output, etc.

One or more input devices 8035 and one or more output devices 8040 are connected to the interface circuit 8030. For example, the input devices 8035 may be used to implement interfaces between the example processors 105 and 110 of FIG. 1.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
sending data from a first process to a second process; and
sending distributed memory check data to the second process, wherein the distributed memory check data represents an initialization state of the data at the first process.

2. A method as defined in claim 1, wherein the data and the distributed memory check data are sent via separate messages.

3. A method as defined in claim 2, wherein the separate messages are constructed in accordance with a messaging passage interface (MPI) standard.

4. A method as defined in claim 1, wherein the data is sent via a first messaging communicator and the distributed memory check data is sent via a shadow messaging communicator.

5. A method as defined in claim 1, further comprising:
intercepting the data as it is being sent by the first process; and
generating the distributed memory check data based on the data.

6. A method as defined in claim 5, wherein the data is intercepted by intercepting a distributed application message sent by the first process.

7. A method as defined in claim 5, wherein intercepting the data is performed by a messaging wrapper implemented between the first process and a messaging interface.

8. A method as defined in claim 5, wherein generating the distributed memory check data is performed by a memory checker.

9. A method as defined in claim 1, further comprising providing the distributed memory check data to a memory checker.

10. A method as defined in claim 1, further comprising using the distributed memory check data to determine if a portion of the data is defined at the second process.

11. A method as defined in claim 1, wherein the distributed memory check data is a plurality of bits, wherein each of the plurality of the bits represent if a portion of the data is defined at the first process.

12. A method comprising:
intercepting data being sent by a first process at a first processor;
acquiring definedness data for the data from a memory checker at the first processor; and
sending the definedness data to a second process at a second processor.

13. A method as defined in claim 12, further comprising:
determining a size of the data; and
allocating a buffer to hold the definedness data based on a size of the data.

14. A method as defined in claim 12, further comprising sending the intercepted data to the second process.

15. A method as defined in claim 12, wherein the definedness data is a plurality of bits, wherein each of the plurality of the bits represent whether a portion of the data is defined at the first processor.

16. An article of manufacture storing machine accessible instructions which, when executed, cause a machine to:
intercept data being sent by a first process at a first processor;
acquire definedness data for the data from a memory checker at the first processor; and
send the definedness data to a second process at a second processor.

17. An article of manufacture as defined in claim 16, wherein the machine accessible instructions, when executed, cause the machine to:
determine a size of the data; and
allocate a buffer to hold the definedness data based on a size of the data.

18. An article of manufacture as defined in claim 16, wherein the machine accessible instructions, when executed, cause the machine to send the intercepted data to the second process.

19. A method comprising:
receiving data at a first processor from a process at a second processor;
receiving definedness data for the data at the first processor; and
using the definedness data to track a memory access of the data by a second process implemented by the first processor.

20. A method as defined in claim 19, further comprising:
determining a size of the data; and
allocating a buffer to hold the definedness data based on a size of the data.

21. A method as defined in claim 19, further comprising sending the intercepted data to a memory checker associated with the first processor, wherein the memory checker tracks the memory access.

22. A method as defined in claim 19, further comprising forwarding the data to a second process implemented by the first processor.

23. A method as defined in claim 19, wherein the definedness data is a plurality of bits, wherein each of the plurality of the bits represent whether a portion of the data is defined at the second processor.
